(19) United States
(12) Patent Application Publication
(10) Pub. No.: US 2004/0195740 A1
(43) Pub. Date: Oct. 7, 2004

(54) Double rolling-lobe air spring

(76) Inventor: Jens-Uwe Gleu, Langenhagen (DE)

Correspondence Address: Walter Ottesen, Patent Attorney, P.O. Box 4026, Gaithersburg, MD, 20885-4026, US

(21) Appl. No.: 10/815,726

(22) Filed: Apr. 2, 2004

(30) Foreign Application Priority Data
Apr. 5, 2003 (DE) 103 15 555.4

(51) Int. Cl. F16F 9/04

(52) U.S. Cl. 267/64.24; 267/64.27; 267/64.21

(57) ABSTRACT

A double rolling-lobe air spring (2) includes an air spring cover (4) and a lower roll-off piston (8). An upper roll-off piston (6) is attached to the air spring cover (4) and the distance between the two roll-off pistons (6, 8) is variable. Respective ends of a double rolling-lobe resilient member (10) are clamped pressure-tight to the lower end of the upper roll-off piston (6) and to the upper end of the lower roll-off piston (8). A foam rubber part (16) is provided between the upper roll-off piston (6) and the rolling-lobe flexible member (10) as a dirt catcher in order to protect the upwardly-directed rolling lobe (10a) of the double rolling-lobe air spring (2) in a simple manner against dirt. The foam rubber part (16) is an insert part between the resilient member (10) and a bracket (18) disposed in surrounding relationship to the resilient member. The bracket (18) is preferably part of a sheet metal assembly of a chassis connection or an roll-off annular member (20).

### CROSS REFERENCE TO RELATED APPLICATIONS

This application claims priority of German patent application no. 103 15 555.4, filed Apr. 5, 2003, the entire content of which is incorporated herein by reference.

### FIELD OF THE INVENTION

The invention relates to a double rolling-lobe air spring having a dirt catcher.

### BACKGROUND OF THE INVENTION

In simple rolling-lobe air springs, the roll-off piston is usually mounted below the rolling-lobe resilient member. Dirt collects in the gap between the piston and rolling-lobe resilient member during a roll-off operation. This dirt can hardly remain adherent because of the rolling lobe which is directed downwardly. A dirt catcher for protecting the rolling lobe is therefore not absolutely necessary.

In contrast to the above, it is different when the roll-off piston is mounted above the rolling-lobe resilient member. Then, an upwardly-directed region is formed on the rolling lobe between the resilient member and the roll-off contour whereat foreign bodies and dirt can collect during the driving operation. These foreign bodies and dirt affect the function of the air spring and can lead to a destruction of the air spring resilient member. It is absolutely necessary in this case to provide a dirt catcher so that dirt cannot collect over a long duration in this upwardly-directed rolling lobe which can operate to destroy the resilient member.

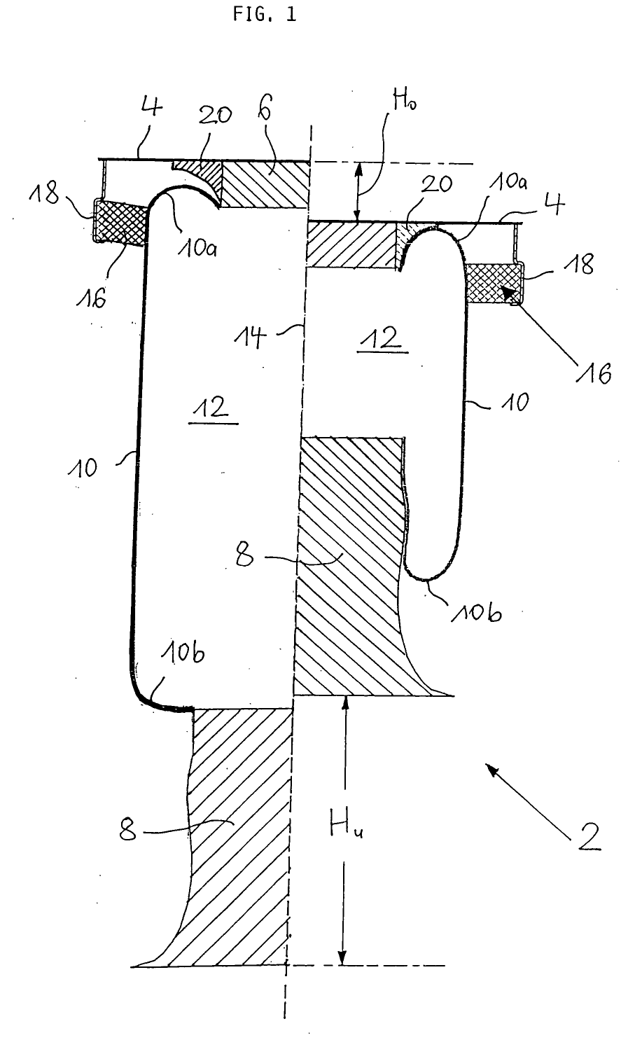

In air springs with a simple rolling-lobe resilient member, bellows are, as a rule, utilized to deflect dirt. These bellows bridge the region, which is to be protected and which is between the base of the roll-off piston and an outer guide ring 11. In this connection, reference can be made to FIG. 1 of German patent publication 199 52 919.

In addition to air springs with simple rolling-lobe resilient elements, air springs having double rolling lobes are also known.

Double rolling-lobe air springs have an upwardly-directed rolling lobe. At least this upwardly-directed rolling lobe should be protected against dirt.

U.S. Pat. No. 4,718,650 discloses a double rolling-lobe air spring wherein the upper roll-off piston is integrated into a cup-shaped bell. During a spring deflection operation or generally, the upper rolling lobe plunges into the intermediate space present between the upper roll-off piston and the cup-shaped bell. A trouble-free dirt catcher function is not provided with this bell.

U.S. Pat. No. 4,493,481 likewise describes a double rolling-lobe air spring. Here, the upper rolling lobe is completely surrounded by an upwardly-closed bell. This bell can be viewed as a dirt catcher.

The disadvantage is that the above configuration is only applicable to such double rolling-lobe air springs wherein a bell is present which is axially moveable relative to the upper roll-off piston.

### SUMMARY OF THE INVENTION

It is an object of the invention to protect the upwardly-directed rolling lobe of a double rolling-lobe air spring from dirt in a simple manner.

The invention is for a double rolling-lobe air spring including: an air spring cover defining an upper roll-off piston having a lower end; a lower roll-off piston at a distance from the upper roll-off piston which distance varies during operation of the air spring and the lower roll-off piston having an upper end; a resilient member having a first end connected to the lower end of the upper roll-off piston and a second end connected to the upper end of the lower roll-off piston; the resilient member forming an upper rolling lobe during operation of the air spring; the resilient member and the upper roll-off piston conjointly defining a region at the upper rolling lobe; and, a part made of foamed material mounted in the vicinity of the upper rolling lobe to function as a contaminant catcher thereby shielding the region from contaminants from the ambient and preventing an accumulation thereof in the region.

According to a feature of the invention, a foam rubber part is utilized as a dirt catcher. In this way, a shielding of the endangered region of the air spring is provided against larger particles from the ambient. A primary advantage of the foam rubber dirt catcher is its simplicity and therefore its cost effectiveness.

A significant difference to the simple rolling-lobe air springs is that the individual rolling lobe of a double rolling-lobe resilient member each has to only operate over approximately half of the stroke. For this reason, and according to a feature of the invention, an expensive bellows or an elastic collar is unnecessary. On the other hand, a protective bellows is also avoided which would increase the outer diameter of the air spring and therefore, as a rule, problematically limits the possible outer diameter of the rolling-lobe resilient member.

At the same time, the foam rubber dirt insulator is superior to partially configured protective bellows which do not extend from the cover to the piston and would have to take up the entire spring deflection path. The advantage is that a contact pressure, which is generated by the elasticity of the foam rubber, does close the region of the upper rolling lobe tight against dirt but not air tight and, at the same time, permits transverse movements caused by the vehicle kinematics and relative movements between bellows wall and foam rubber caused by long deflection paths without losing tightness. Additionally, there is no rub-off on the rolling-lobe resilient member because of the softness of the foam rubber relative to the resilient member.

This foam part is preferably formed as an annular element and can lie elastically pressed between the resilient member and the vehicle chassis and/or especially as an insert part between the resilient member and a bracket surrounding the resilient member. This bracket, for example, can be a part of the sheet metal construction of the chassis connection or of the roll-off ring or the like. The ring as well as the bracket can be configured to be rotationally symmetrical about the air spring longitudinal axis or can be configured to not be rotationally symmetrical.

In total, the following advantages are provided by the dirt catcher of the invention:

(a) the relatively complicated component for insulating the endangered region against the ambient made of bellows or elastic collars is replaced by a very inexpensive component made of foamed elastomer;

(b) the venting function is integrated because of the porosity of the foam;

(c) a high elasticity and therefore a sealing function in radial direction and in transverse direction can be realized by the special characteristics of the foam rubber;

(d) no rubbing or rub-off problems occur on the outer surface of the resilient member because of the special characteristics of the foam rubber; and,

(e) damage of the protection, for example, by stones thrown up from the roadway, is prevented by the special characteristics of foam rubber.

### BRIEF DESCRIPTION OF THE DRAWING

The invention will now be described with reference to the single figure (FIG. 1) of the drawing which shows a schematic of an air spring of the invention in longitudinal section. The left half portion of FIG. 1 shows the air spring in the expanded state and the right half shows the air spring in the deflected state.

### DESCRIPTION OF THE PREFERRED EMBODIMENTS OF THE INVENTION

The air spring 2 of the invention is based on a conventional double rolling-lobe air spring. Such a double rolling-lobe air spring comprises essentially an air spring cover 4 having an upper roll-off piston 6 and a lower roll-off piston 8 which is at a variable distance to the upper roll-off piston 6. Respective ends of the double rolling-lobe resilient member 10 are clamped pressure tight to the lower end of the upper roll-off piston 6 and the upper end of the lower roll-off piston 8. The double rolling-lobe resilient member 10 and the two upper and lower roll-off pistons (6, 8) enclose the volume-changing interior space 12 of the air spring.

With a spring deflection operation, a relative movement of the two roll-off pistons with respect to each other takes place along the common longitudinal axis 14.

When such an air spring 2 is built in downside down, then a region is present on the upper rolling lobe 10a between the resilient member 10 and the roll-off contour whereat dirt and foreign bodies can collect during operation of the air spring. This negatively affects the function of the air spring 2 or leads to a destruction of the air spring resilient member 10.

The invention provides for the use of a foam rubber part 16 for shielding the endangered region against larger particles from the ambient. In the embodiment of FIG. 1, the foam rubber part 16 is configured as an annular member as shown. This annular element 16 is disposed as an insert part between the resilient member 10 and a bracket 18 surrounding the resilient member. The bracket 18 is part of a sheet metal assembly connected to the chassis. The annular element 16 as well as the bracket 18 can be configured to be rotationally symmetric about the air spring longitudinal axis 14 or can be configured to be non-rotationally symmetric.

The foam rubber annular member 16 is fixedly connected to the cover 4. With a slight press fit relative to the resilient member 10, an upward and downward slippage is avoided. Smaller relative movements in the transverse and vertical directions are elastically compensated. Larger vertical relative movements of the resilient member 10 against the bracket 18 of the foam rubber annular member 16 are compensated by sliding of the foam rubber 16 on the resilient member 10. The maximum possible stroke H₀ of the upper rolling lobe 10a is shown greater in the right half portion of FIG. 1 than in the left half portion and is usually not utilized. The annular member 16 is made of open-pore foam rubber and keeping the annular member 16 clean can be achieved, for example, by providing the annular member as an injected rubber form part having a closed skin.

The foam rubber part 16 can be attached to the resilient member 10 in lieu of being attached to an annular bracket 18 while it lies elastically against the chassis or cover 4.

In the present embodiment, an roll-off annular element 20 is provided between the cover 4 and the upper piston 6.

It is understood that the foregoing description is that of the preferred embodiments of the invention and that various changes and modifications may be made thereto without departing from the spirit and scope of the invention as defined in the appended claims.

What is claimed is:

1. A double rolling-lobe air spring comprising:
an air spring cover defining an upper roll-off piston having a lower end;
a lower roll-off piston at a distance from said upper roll-off piston which distance varies during operation of the air spring and said lower roll-off piston having an upper end;
a resilient member having a first end connected to said lower end of said upper roll-off piston and a second end connected to said upper end of said lower roll-off piston;
said resilient member forming an upper rolling lobe during operation of said air spring;
said resilient member and said upper roll-off piston conjointly defining a region at said upper rolling lobe; and,
a part made of foamed material mounted in the vicinity of said upper rolling lobe to function as a contaminant catcher thereby shielding said region from contaminants from the ambient and preventing an accumulation thereof in said region.

2. The double rolling-lobe air spring of claim 1, further comprising: a bracket disposed in surrounding relationship to said resilient member; and, said part being mounted as an insert between said resilient member and said bracket.

3. The double rolling-lobe air spring of claim 1, wherein said air spring is mounted in a vehicle having a chassis and said part made of foamed material is configured as an annular member; and said annular member is attached to the outer wall of said resilient member and is in elastic contact with said chassis.

4. The double rolling-lobe air spring of claim 1, wherein said foamed material is an open-pore material.

5. The double rolling-lobe air spring of claim 2, wherein said air spring is mounted in a vehicle having a chassis and said air spring further comprises a sheet metal assembly defining said bracket.

6. The double rolling-lobe air spring of claim 2, wherein said bracket is formed as part of said cover.

7. The double rolling-lobe air spring of claim 2, wherein said air spring defines a longitudinal axis; and, said bracket and said part of foamed material are rotationally symmetrical about said longitudinal axis.

8. The double rolling-lobe air spring of claim 2, wherein said air spring defines a longitudinal axis; and, said bracket and said part of foamed material are rotationally non-symmetrical about said longitudinal axis.
